(19) United States
(12) Patent Application Publication
(10) Pub. No.: US 2009/0007958 A1
(43) Pub. Date: Jan. 8, 2009

(54) PORTABLE SOLAR ENERGY SUPPLYING DEVICE

(75) Inventors: CHING-CHING HO, TAIPEI CITY 114 (TW); JR-REN JI, TAIPEI CITY 114 (TW); YI-HAO LIN, TAIPEI CITY 114 (TW)

Correspondence Address: ROSENBERG, KLEIN & LEE, 3458 ELLICOTT CENTER DRIVE-SUITE 101, ELLICOTT CITY, MD, 21043, US

(73) Assignee: TSANN KUEN ENTERPRISE CO., LTD., TAIPEI CITY 114 (TW)

(21) Appl. No.: 11/772,516

(22) Filed: Jul. 2, 2007

(51) Int. Cl. H02N 6/00; H01M 10/46

(52) U.S. Cl. 136/245; 320/101

(57) ABSTRACT

A portable solar energy supplying device includes a body, a solar energy board, a secondary battery, a charging circuit, and a control unit. The body has a receiving space. The solar energy board is received in the receiving space, and receives solar energy and converts the solar energy into electrical power when the solar energy board is unfolded outside of the receiving space. The charging circuit is electrically connected with the solar energy board for receiving the electrical power converted by the solar energy board to charge the secondary battery. The control unit is electrically connected to the secondary battery for adjusting the output voltage of the secondary battery for an application system. Thereby, the goals of charging and supplying solar energy are achieved. The occupied space is reduced, it is convenient for the user to carry it, and the solar energy board is protected.

### BACKGROUND OF THE INVENTION

1. Field of the Invention

The present invention relates to a solar energy supplying device. In particular, this invention relates to a solar energy supplying device that is portable and can protect the solar energy board.

2. Description of the Related Art

Because industry and technology have become highly developed in the last two hundred years, our way of living and our environment has changed enormously. Recently, energy shortages and the problems associated with fossil fuels have become of increasing concern to people all over the planet. In order to cope with the needs for energy, an alternative energy industry has arisen. Furthermore, because people pay much attention nowadays to environmental protection and quality of life issues, people do not wish to use chemical materials that will damage the environment in the process of developing energy. Solar energy is an excellent, renewable source of energy that meets the requirements of environmental protection.

There are a variety of products that relate to solar energy in our daily life. However, converting solar energy into electrical power is performed by shining sunlight on a solar energy board for a long time. The bigger the receiving area is, the more power can be generated. The dimensions of solar energy products are usually very large and must be located on a specified location or object. If not they can only be applied to a product that requires small amounts of power.

As consumer electronic devices have become more popular, the battery module that determines how long the devices can be used for is a key factor. In order to continuously operate a device for a long time, a high capacity battery is used. Alternatively, a power-saving system can be designed for the device. Another option is for the user also to carry a spare battery with them. However, when the device cannot be supplied with power, the battery in the device will become exhausted after it has been used for a period of time. The above methods therefore cannot fully solve the problem.

Therefore, how to supply energy anytime, anywhere and not damage the environment in the developing process while meeting consumer requirements is an issue. For portable devices, their portability and how to replace spare batteries is also a concern.

### SUMMARY OF THE INVENTION

One particular aspect of the present invention is to provide a solar energy supplying device. The solar energy board can be folded. When the user carries the solar energy supplying device around, the solar energy board can be folded and received in the solar energy supplying device. The required space is small and it is convenient for the user to carry it. The solar energy supplying device and the portable device can be carried together. Thereby, the goals of charging and supplying solar energy are achieved. It can supply power to the portable device, and charge the battery at the same time.

The portable solar energy supplying device includes a body, a solar energy board, a secondary battery, a charging circuit, and a control unit. The body has a receiving space. The solar energy board receives the solar energy and converts the solar energy into electrical power. The charging circuit is electrically connected between the solar energy board and the secondary battery for receiving the electrical power converted by the solar energy board to charge the secondary battery. The control unit is electrically connected to the secondary battery for adjusting the output voltage of the secondary battery for an external application system. The solar energy originally can be received in the receiving space. When the solar power supply device executes the solar power charging process, the solar energy is unfolded to receive and convert the solar energy.

In another embodiment, the portable solar energy supplying device includes a body, a rotating shaft, at least one solar energy board, a secondary battery, a charging circuit, and a control unit. The body includes a base and a cover. The rotating shaft is used for connecting the base with the cover so that the body can be unfolded to form an open-close plane. The solar energy board is located on the open-close plane. When the open-close plane is unfolded, the solar energy board is displayed for receiving the solar energy and converting it into electrical power. The charging circuit is electrically connected between the solar energy board and the secondary battery for receiving the electrical power converted by the solar energy board to charge the secondary battery. The control unit electrically connects to secondary battery for adjusting the output voltage of the secondary battery for an external application system. When the solar energy board is not being used, the dimensions of the solar energy supplying device will not increase. It is convenient for the user to carry around. The solar energy supplying device and the application system can be carried together so that power can be supplied to the application system at anytime, anywhere.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of the portable solar energy supplying device of the present invention;

FIG. 2 is a schematic diagram of the portable solar energy supplying device of the first embodiment of the present invention;

FIG. 3 is a schematic diagram of the portable solar energy supplying device of the second embodiment of the present invention;

FIG. 4 is a schematic diagram of the portable solar energy supplying device of the third embodiment of the present invention; and

FIG. 5 is a schematic diagram of the portable solar energy supplying device of the fourth embodiment of the present invention.

### DETAILED DESCRIPTION OF THE PREFERRED EMBODIMENTS

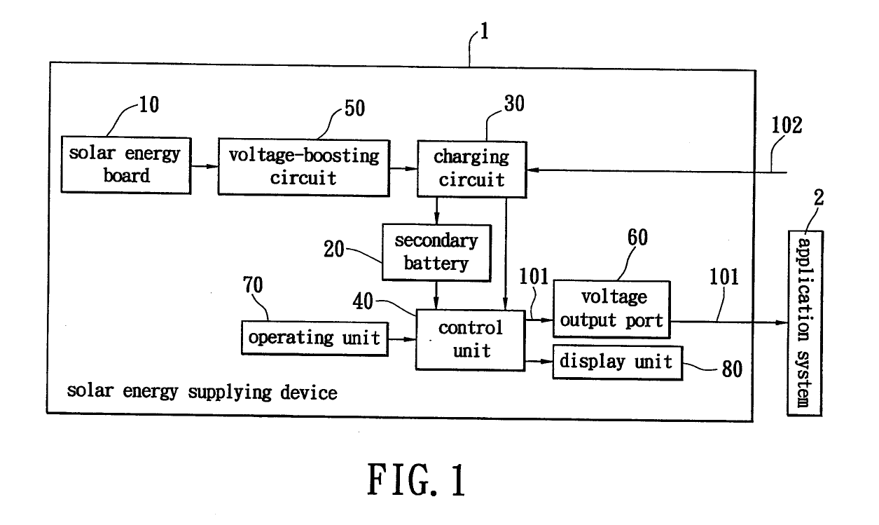

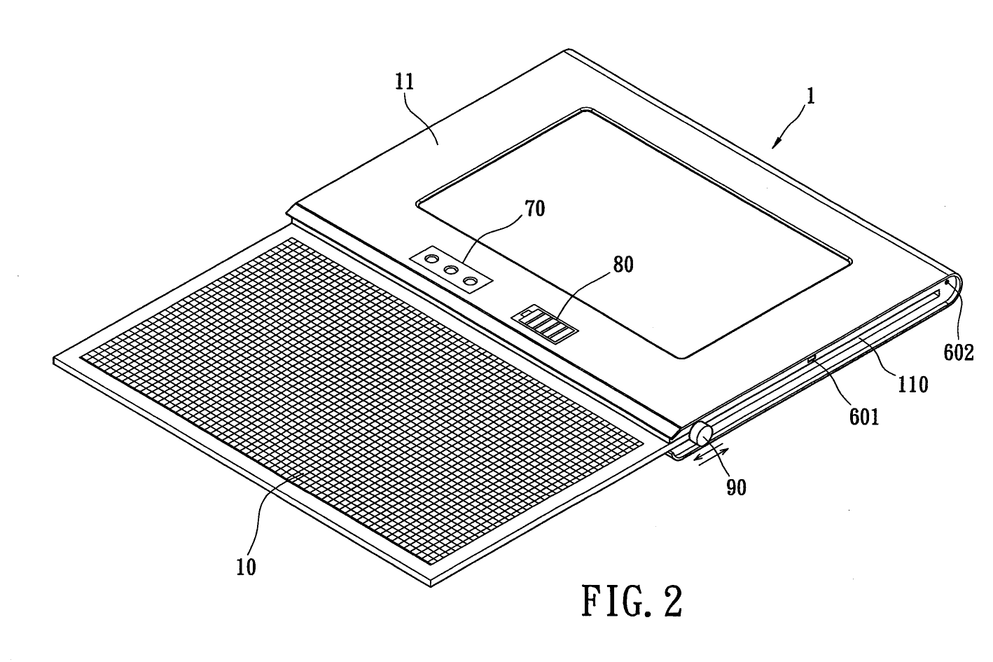

Reference is made to FIGS. 1 and 2, which show a block diagram of the portable solar energy supplying device of the present invention and a schematic diagram of the first embodiment of the present invention. The solar energy supplying device 1 includes a body 11, a solar energy board 10, a secondary battery 20, a charging circuit 30, a control unit 40, a voltage-boosting circuit 50, a voltage output port 60, an operating unit 70, and a display unit 80. The body 11 has a receiving space 110. When the solar energy board 10 is not being used for receiving solar energy, the solar energy board 10 is received in the receiving space 110. It is convenient for the user to carry around, and the solar energy board 10 can be protected so that it will not be damaged. When the solar energy board 10 is unfolded and located outside of the receiving space 110, the solar energy board 10 receives the solar energy and converts the solar energy into electrical power. In a first embodiment, the user pushes or pulls the solar energy board 10 to make the solar energy board 10 be received in the receiving space 110 or unfolded and located outside of the receiving space 110. Furthermore, one side of the solar energy board 10 is connected with a moving rod 90. The user can push or pull the moving rod 90 to fold or unfold the solar energy board 10.

The voltage-boosting circuit 50 is electrically connected with the solar energy board 10 for boosting the voltage outputted from the solar energy board 10 and stabilizing the voltage to form a fixed voltage. In this embodiment, the fixed voltage is 5 volts. The charging circuit 30 is electrically connected between the voltage-boosting circuit 50 and the secondary battery 20 for receiving the fixed voltage outputted from the voltage-boosting circuit 50 to charge the secondary battery 20. In order to increase the amount of stored power and power supplying ability of the secondary battery 20, the secondary battery 20 is a lithium battery. Thereby, the power storing ability of the solar energy supplying device 1 is increased, and power can be supplied to the application system 2 for a longer time.

The control unit 40 is electrically connected the secondary battery 20 for controlling the voltage of the secondary battery 20 to generate at least one output voltage 101. The output voltage 101 is supplied to the external application system 2 via the voltage output port 60. The user can use the operating unit 70 electrically connected with the control unit 40 to adjust the magnitude of the output voltage 101 to meet the requirements of the application system 2. The voltage required for the control unit 40 is supplied by the charging circuit 30. The operating unit 70 can be a key or a knob. In the first embodiment, a key is used as an example.

Furthermore, the user can select different voltage output ports 60 according to the connecting interface and the operating voltage of the application system 2. In the first embodiment, the USB connecting port 601 and the power connecting port 602 are used as examples. If the interface of the application system 2 is a USB interface, the operating voltage is 5 volts. The user connects the application system 2 to the USB connecting port 601 to receive the 5 volts controlled by the control unit 40 to operate or charge the application system 2. Similarly, if the connected application system 2 is a portable computer, the user uses the operating unit 70 to adjust the output voltage 102 to be 19 volts. Thereby, the user can connect the power of the portable computer to the power connecting port 602 for receiving the output voltage 101 provided by the secondary battery 20 in the solar energy supplying device 1.

Moreover, the control unit 40 can be built-in with a voltage detection function to detect the voltage level of the secondary battery 20 to control and output different output voltages 101. The display unit 80 is electrically connected with the control unit 40, and receives a control from the control unit 40. Similarly, the control unit 40 controls the display unit 80 according to the detected voltage level of the secondary battery 20 to display the power status or charging status of the secondary battery 20. Furthermore, the display unit 80 can display the output voltage 101 adjusted by the user via the operating unit 70. In actual application, the display unit 80 can be a screen but is not limited to a specified kind. Alternatively, the display unit 80 can be formed by a plurality of LEDs that have a displaying and indicating effect. In the first application, the display unit 80 is a screen, and the display unit 80 uses a battery figure to display the power status of the secondary battery 20.

When the user is outdoors or any place with enough sunshine, the user can use the solar energy board 10 of the solar energy supplying device 1 to perform the electrical power converting process and charge the secondary battery 20. When the amount of sunshine is inadequate, the secondary battery 20 cannot be charged. The charging circuit 30 can be connected with a power outlet 102 to charge the secondary battery 20. Thereby, the secondary battery 20 is continuously charged and has adequate output voltage 101 for the application system 2.

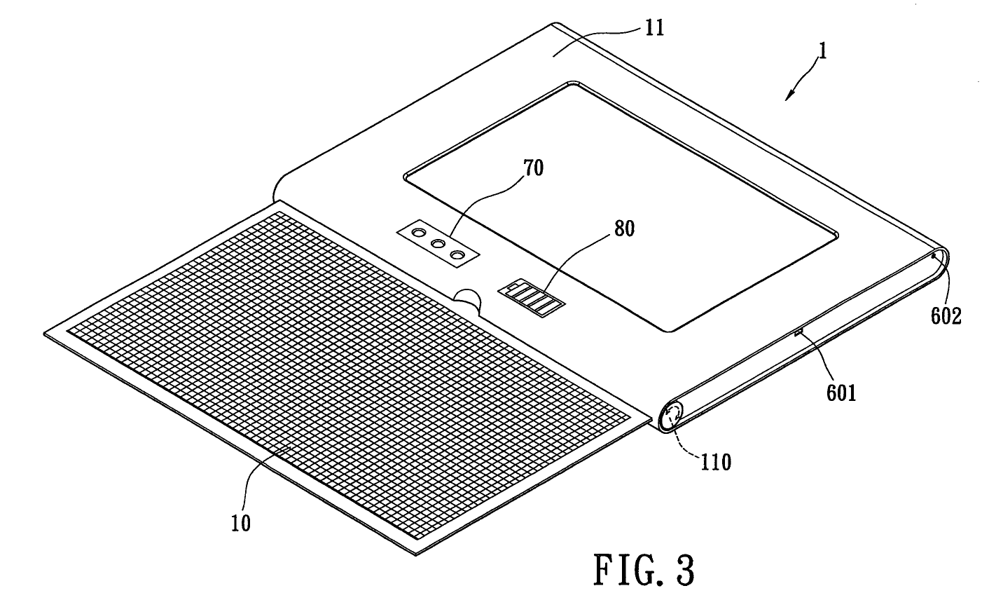

Reference is made to FIG. 3, which shows a schematic diagram of the portable solar energy supplying device of the second embodiment of the present invention. The difference between the second embodiment and the first embodiment is that the solar energy board 10 is a slim-film solar energy board. Therefore, the total weight is reduced. By utilizing the characteristic of the slim-film solar energy board—that it can be rolled up—the receiving space 110 can be further decreased. As is shown in the figure, the receiving space 110 has a cylinder-like shape so the slim-film solar energy board can be rolled up in the receiving space 110. When the slim-film solar energy board is rolled up in the receiving space 110, the slim-film solar energy board can be protected from being damaged. When the solar energy charging process is being performed, the slim-film solar energy board is pulled out from the receiving space 110 to receive solar energy.

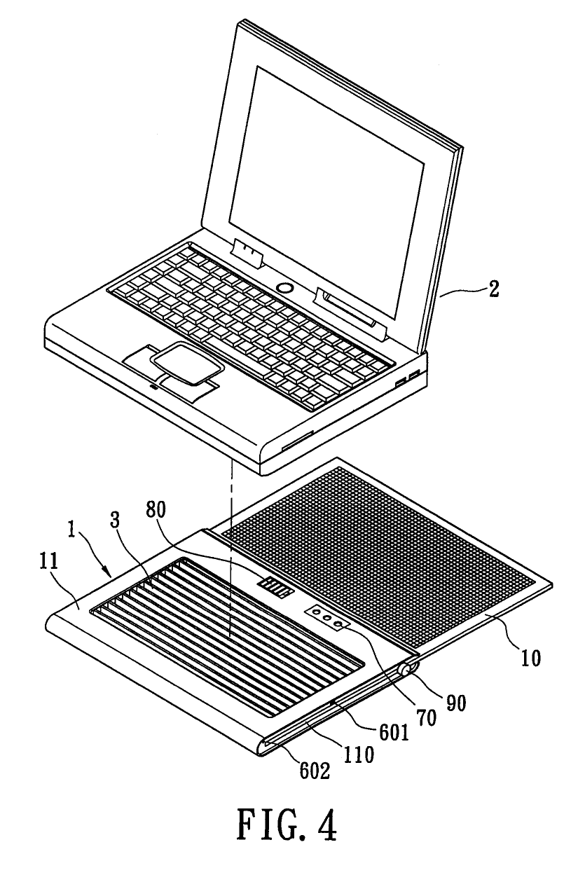

Reference is made to FIG. 4, which shows a schematic diagram of the portable solar energy supplying device of the third embodiment of the present invention. The body 11 of the solar energy supplying device 1 is further embedded with a cooling board 3. When the user places the application system 2 (such as a portable computer) on the solar energy supplying device 1 to reduce the occupied space, heat can be exhausted from the cooling board 3 of the body 11.

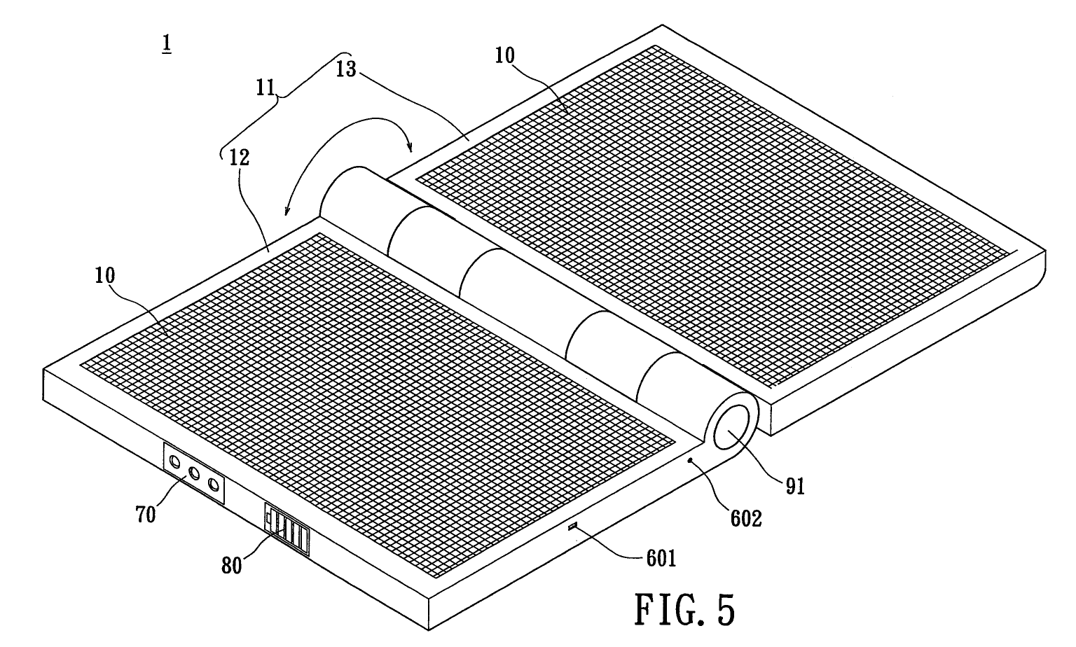

Reference is made to FIG. 5, which shows a schematic diagram of the portable solar energy supplying device of the fourth embodiment of the present invention. The solar energy supplying device 1 is almost identical to the third embodiment. The difference is that the solar energy supplying device 1 further includes a rotating shaft 91, and the body 11 includes a base 12 and a cover 13. The rotating shaft 91 is used for connecting the base 12 with the cover 13 so that the body 11 can be unfolded to form an open-close plane. The solar energy board 10 is located on the open-close plane. When the user wishes to perform the solar energy charging process, the user unfolds the base 12 and the cover 13 via the rotating shaft 91 to display the solar energy board 10 to receive solar energy and convert it into electrical power. When the user wishes to carry the solar energy supplying device 1, the user folds the base 12 and the cover 13 via the rotating shaft 91. The occupied space is lowered, and it is convenient to carry. The solar energy board 10 is protected and cannot be damaged.

In the above embodiments, the type or quantity of the voltage output port 60, or the location of the voltage output port 60 on the solar energy supplying device 1 is not used to limit the scope of the present invention. The operating unit 70, the display unit 80, or the method of the solar energy board 10 received in the receiving space 110 are also not limited to above description.

The solar energy board 10 can be folded. When the user carries the solar energy supplying device 1 around, the solar energy board 10 can be folded and received in the solar energy supplying device 1. The required space is small and the solar energy board 10 is protected and cannot be damaged. When the sun is shining, the goals of charging and supplying solar energy anywhere can be achieved. It can both supply power to the application and charge the secondary battery 20. Therefore, when the solar energy supplying device 1 cannot receive solar energy, the secondary battery 20 can be used as the power source.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A portable solar energy supplying device, comprising:
a body having a receiving space;
a solar energy board received in the receiving space, wherein the solar energy board receives solar energy and converts solar energy into electrical power when the solar energy board is unfolded and is located outside of the receiving space;
a secondary battery for storing electrical energy;
a charging circuit electrically connected between the solar energy board and the secondary battery for receiving the electrical power converted by the solar energy board to charge the secondary battery; and
a control unit electrically connected to the secondary battery for controlling the secondary battery to output at least one output voltage to an application system.

2. The portable solar energy supplying device as claimed in claim 1, wherein the body further is embedded with a cooling board for exhausting heat when the application system is placed on the body.

3. The portable solar energy supplying device as claimed in claim 1, wherein the solar energy board is a slim-film solar energy board.

4. The portable solar energy supplying device as claimed in claim 1, wherein the solar energy board is unfolded to an outside of the receiving space by pulling.

5. The portable solar energy supplying device as claimed in claim 1, wherein the secondary battery is a lithium battery.

6. The portable solar energy supplying device as claimed in claim 1, wherein the charging circuit further is connected to a power outlet to charge the secondary battery.

7. The portable solar energy supplying device as claimed in claim 1, wherein the output voltage is outputted via at least one voltage output port.

8. The portable solar energy supplying device as claimed in claim 7, wherein the voltage output port is a USB connecting port or a power connecting port.

9. The portable solar energy supplying device as claimed in claim 1, further comprising a voltage-boosting circuit, wherein the voltage-boosting circuit is electrically connected between the solar energy board and the charging circuit for boosting the voltage and stabilizing the voltage to a fixed voltage and supplying the voltage to the charging circuit.

10. The portable solar energy supplying device as claimed in claim 9, wherein the fixed voltage is 5 volts.

11. The portable solar energy supplying device as claimed in claim 1, further comprising an operating unit, wherein the operating unit is electrically connected with the control unit for controlling the control unit to adjust the magnitude of the output voltage.

12. The portable solar energy supplying device as claimed in claim 11, wherein the operating unit is a key or a knob.

13. The portable solar energy supplying device as claimed in claim 1, further comprising a display unit, wherein the display unit is electrically connected with the control unit for receiving control from the control unit to display the power status, the charging status, or the magnitude of the output voltage of the secondary battery.

14. The portable solar energy supplying device as claimed in claim 13, wherein the display unit is a screen or LEDs.

15. A portable solar energy supplying device, comprising:
a body having a base and a cover;
a rotating shaft used for connecting the base with the cover so that the body is unfolded to form an open-close plane.
At least one solar energy board located on the open-close plane, wherein the solar energy board receives solar energy and converts solar energy into electrical power when the open-close plane is unfolded to display the solar energy board;
a secondary battery for storing electrical energy;
a charging circuit electrically connected between the solar energy board and the secondary battery for receiving the electrical power converted by the solar energy board to charge the secondary battery; and
a control unit electrically connected secondary battery for controlling the secondary battery to output at least one output voltage to an application system.

16. The portable solar energy supplying device as claimed in claim 15, wherein the secondary battery is a lithium battery.

17. The portable solar energy supplying device as claimed in claim 15, wherein the charging circuit further connects to a power outlet to charge the secondary battery.

18. The portable solar energy supplying device as claimed in claim 15, wherein the output voltage is outputted via at least one voltage output port.

19. The portable solar energy supplying device as claimed in claim 18, wherein the voltage output port is a USB connecting port or a power connecting port.

20. The portable solar energy supplying device as claimed in claim 15, further comprising a voltage-boosting circuit, wherein the voltage-boosting circuit is electrically connected between the solar energy board and the charging circuit for boosting the voltage and stabilizing the voltage to a fixed voltage and supplying to the charging circuit.

21. The portable solar energy supplying device as claimed in claim 20, wherein the fixed voltage is 5 volts.

22. The portable solar energy supplying device as claimed in claim 15, further comprising an operating unit, wherein the operating unit is electrically connected with the control unit for controlling the control unit to adjust the magnitude of the output voltage.

23. The portable solar energy supplying device as claimed in claim 22, wherein the operating unit is a key or a knob.

24. The portable solar energy supplying device as claimed in claim 15, further comprising a display unit, wherein the display unit is electrically connected with the control unit for receiving control from the control unit to display the power status, the charging status, or the magnitude of the output voltage of the secondary battery.

25. The portable solar energy supplying device as claimed in claim 24, wherein the display unit is a screen or LEDs.
